(19) United States
(12) Patent Application Publication
(10) Pub. No.: US 2006/0117723 A1
(43) Pub. Date: Jun. 8, 2006

(54) Cyclone dust-separating apparatus

(75) Inventor: Dong-Hun Yoo, Gwangju-City (KR)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Samsung Gwangju Electronics Co., Ltd

(21) Appl. No.: 11/072,362

(22) Filed: Mar. 4, 2005

(30) Foreign Application Priority Data
Dec. 2, 2004 (KR) 2004-100536

(51) Int. Cl. B01D 47/00

(52) U.S. Cl. 55/428

(57) ABSTRACT

Disclosed is a cyclone dust-separating apparatus with high efficiency on the collection of microscopic particulates of dust without clogging filters. The cyclone dust-separating apparatus includes: a cyclone body; and at least one dust collection unit formed on a circumferential surface of the cyclone body, wherein the at least one dust collection unit collects microscopic particulates of dust.

### CROSS-REFERENCE TO RELATED APPLICATIONS

This application claims the benefit of Korean Patent Application No. 2004-100536, filed on Dec. 2, 2004, in the Korean Intellectual Property Office, the disclosure of which is incorporated herein by reference.

### BACKGROUND OF THE INVENTION

1. Field of the Invention

The present invention relates to a cyclone dust-separating apparatus; and more particularly, to a cyclone dust-separating apparatus for separating dust and air from dust-ladened air drawn in through the use of centrifugation.

2. Description of the Related Art

Generally, a cyclone dust collecting apparatus revealed in the Korean Laid-Open No. 2002-0091510 issued to M. J. Choi on Dec. 6, 2002, entitled “Cyclone Dust Collecting Apparatus For a Vacuum Cleaner” includes: a cyclone body in which centrifugation and dirt collection take place; an inlet passage formed on a circumferential surface of the cyclone body; and an outlet passage formed on an upper portion of the cyclone body. Inside of the cyclone body, a grill connected with the outlet passage is installed, and a skirt is installed at a bottom portion of the grill.

Under the above configuration, the dust-laden air flowing into the inlet passage is separated into air and dust, and the dust is piled up at the bottom of the cyclone body, while the air exhausts out of the cyclone body through the outlet passage.

Meanwhile, the skirt prevents the collected dust precedently separated from the cyclone body from ascending, and the grill prevents dust that is not centrifuged at the cyclone body and dust that detours around the skirt from exhausting out of the outlet passage.

However, although the cyclone dust collecting apparatus is capable of preventing large and small particles of dust from flowing out of the outlet passage in some degrees, the cyclone dust is still limited in preventing those microscopic particulates of dust from exhausting out of the outlet passage. Therefore, the microscopic particulates exhausted without passing through the skirt and the grill clog a motor protection filter and an exhaust filter and as a result, a suction power of a vacuum cleaner becomes weakened.

### SUMMARY OF THE INVENTION

It is, therefore, an aspect of the present invention to provide a cyclone dust-separating apparatus improved with collecting microscopic particulates of dust.

It is another aspect of the present invention to provide a cyclone dust-separating apparatus with an improvement on a problem related to a clogged filter.

In accordance with one aspect of the present invention, there is provided a cyclone dust-separating apparatus, including: a cyclone body; and at least one dust collection unit formed on a circumferential surface of the cyclone body, wherein the at least one dust collection unit collects microscopic particulates of dust.

Herein, the at least one dust collection unit includes: a pocket protruded from an exterior surface of the cyclone body; a pocket lid for covering the pocket; and a screen disposed in the pocket, and the pocket, the pocket lid and the screen create an enclosed space. It is preferred that microscopic particulates of dust existing within an interior space of the cyclone body are collected at the enclosed space.

Also, the screen preferably has the same circumference to an inner sidewall of the cyclone body in order to prevent the screen from protruding toward an inner part of the cyclone body. It is also preferred that the screen includes a plurality of dust passage openings and the number of the dust passage openings increases as going up from a bottom part of the screen to an upper part of the screen. At this time, each of the dust passage openings has a diameter that decreases as going from the interior space to the enclosed space.

In addition, the screen preferably includes a plurality of vertical slits each being inclined in a direction to which air existing within the interior space rotates.

Furthermore, it is preferable to make the screen attachable to and detachable from the pocket.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view showing a cyclone dust-separating apparatus in accordance with the present invention;

FIG. 2 is a diagram showing the cyclone dust-separating apparatus cross-sectioned in a direction of a line II-II illustrated in FIG. 1;

FIG. 3 is a perspective view showing the cyclone dust-separating apparatus of which upper part is separated from the cyclone dust-separating apparatus shown in FIG. 1;

FIG. 4 is an enlarged perspective view showing one embodied screen illustrated in FIG. 3;

FIG. 5 is a diagram showing the cyclone dust-separating apparatus cross-sectioned in a direction of a line V-V illustrated in FIG. 1 utilizing the screen of FIG. 4;

FIG. 6 is a perspective view showing another embodied screen in accordance with the present invention; and

FIG. 7 is a diagram showing the cyclone dust-separating apparatus cross-sectioned in the direction of line V-V illustrated in FIG. 1 utilizing the screen of FIG. 6.

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

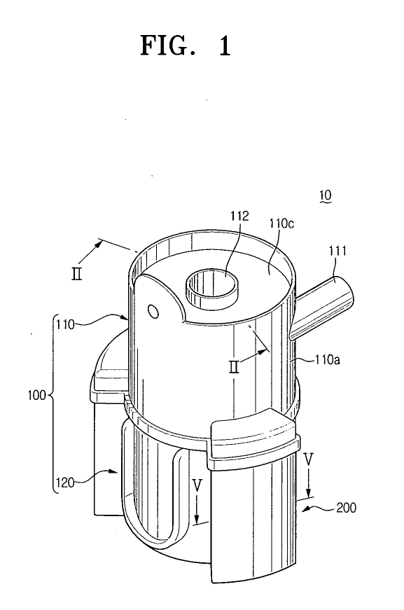

With reference to FIGS. 1 to 3, a cyclone dust-separating apparatus 10 includes: a cyclone body 100 divided into an upper body 110 and a lower body 120; and a dust collection unit 200.

The upper body 110 is a cylindrical container in which dust is separated from dust-laden air. For this function of the upper body 110, a pipe-type inlet passage 111 for sucking the dust-laden air into the cyclone body 100 is formed on an upper outer sidewall 110a of the upper body 110 and a pipe-type outlet passage 112 for exhausting air separated from the dust is formed on a top surface 110c of the cyclone body 100.

A grill 113 connected with the outlet passage 112 is installed in a central part of the upper body 110, and a funnel-type skirt 114 is formed at a bottom side of the grill 113. Particularly, the skirt 114 prevents the collected dust from ascending again, and the grill prevents dust that ascends as diverting from the skirt 114 and dust that is not centrifuged from exhausting out of the outlet passage 112. Also, the grill 113 includes a plurality of exhaust openings 113a for exhausting air.

The lower body 120 is a cylindrical container in which the dust-laden air is centrifuged and the separated dust is collected and, is connected with the upper body 110 in a separable manner at a bottom side of the upper body 110.

On a bottom surface 120c of the lower body 120, three trapezoidal anti-flowing columns 121 for impeding the collected dust from flowing around the cyclone body 100 are disposed. The number and shape of the anti-flowing columns 121 can be changed depending on needs. While the cyclone body 100 is divided into the upper body 110 and the lower body 120 in this exemplary embodiment, alternatively the upper body 110 can be integrally formed with the lower body 120 as occasion demands, thereby obtaining an integral structure of the cyclone body 100. In this exemplary embodiment, the lower portion of the integral cyclone body 100 is configured to be opened and closed to exhaust dust out of the cyclone body 100.

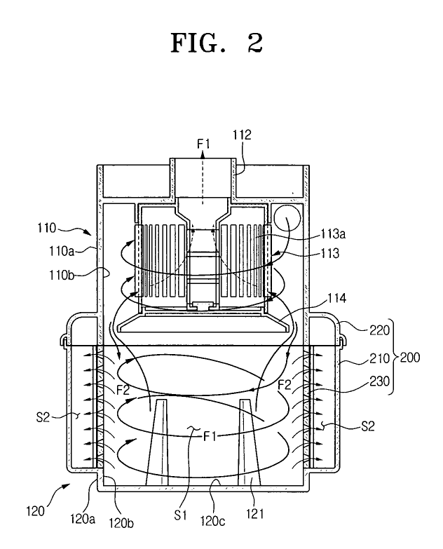

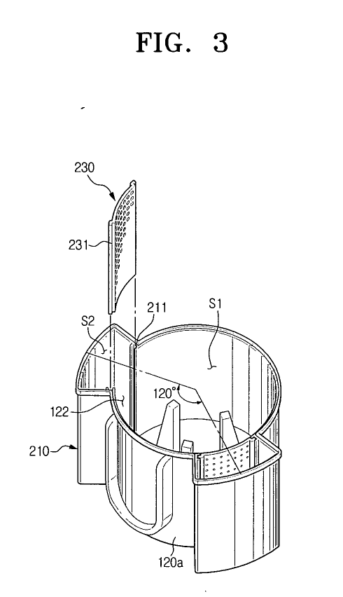

Referring to FIGS. 2 and 3, the dust collection unit 200 includes a pocket 210, a pocket lid 220 and a screen 230, which create an enclosed space S2 at which microscopic particulates are collected. Also, it should be noted that a plurality of the dust collection units 200 are disposed on respective circumferential portions of the cyclone body 100. In this embodiment of the present invention, the dust collection unit 200 is allocated in every angle of approximately 120°. Hereinafter, detailed configuration of the dust collection units 200 will be described, and it should be noted that each of the dust collection units 200 has the same configuration.

The pocket 210 is a trapezoidal dust collection container of which the upper part is opened. The pocket 210 is preferably formed to protrude outwardly from a lower outer sidewall 120a of the lower body 120. At a region where the pocket 210 is formed, there is a connection opening 122 for making a connection between the enclosed space S2 and an interior space S1 of the cyclone body 100. Also, in addition to the formation of the pocket 210 at the lower body 120, the pocket 210 can be formed to protrude outwardly over a portion of the cyclone body 100, i.e., from the upper body 110 to the lower boy 120, depending on needs. Furthermore, the pocket 210 can be formed in alternative shapes, such as, for example, triangular or circular.

As illustrated in FIG. 2, the pocket lid 220 covers the opened upper part of the pocket 210. The pocket lid 220 can preferably be formed as an integral structure with the upper body 110 by using a molding material or technique. Alternatively, the pocket lid 220 can be formed separately and then, glued, welded or otherwise connected to the upper outer sidewall 110a of the upper body 110. The pocket lid 220 is formed on the upper outer sidewall 110a corresponding to the number and position of the pocket 210, such that the pocket lid 220 covers the pocket 210 when the upper body 110 and the lower body 120 are connected.

Referring to FIGS. 3 to 5, the screen 230 is an isolated wall preferably having a curved or arcuate shape. The screen 230 can be attachable to or detachable from the pocket 210 to define the trapezoidal shape of the pocket. To make the screen 230 attachable and detachable, rails 211 are formed on inner sidewalls of the pocket 210 in the shape of a trench. Also, guide protrusions 231 are formed at both end sides of the screen 230 such that the guide protrusions 231 individually interlock with the rails 211. That is, as shown more clearly in the cross-sectional view of FIG. 5, the rails 211 and the guide protrusions 231 are formed in U-shapes and L-shapes, respectively. As a result of the reciprocal combination between each two of the guide protrusions 231 and the rails 211, the screen 230 can slide along the pocket 210.

Alternatively, the screen 230 can be connected with the pocket 210 in a hinge mode that allows one side of the screen 230 to be opened, or the screen 230 can be fixed at the pocket 210 by being glued, welded or otherwise connected thereto. It is further possible to form the screen 230 and the pocket 210 in an integral structure. In spite of these various possible configurations of the screen 230 and the pocket 210, it is preferable to form the screen 230 to be attached to or detached from the pocket 210 for convenience in cleaning and repairing the screen 230 as shown in this embodiment. Additionally, the present disclosure contemplates other structures and techniques for connecting the screen 230 with the pocket 210.

Meanwhile, a support protrusion 212, preferably having a substantially rectangular or square shape, is formed on a bottom surface of the pocket 210 for the purpose of firmly supporting the screen 230. Thus, the rails 211 and the support protrusion 212 give a firm support to the screen 230. It is still possible to form two or more support protrusions 212 to support the screen 230 and alternative shapes for the protrusions are also contemplated, such as, for example, rectangular with an arcuate face that corresponds to the arcuate shape of the screen.

Also, the screen 230 is incorporated into a lower inner sidewall 120b of the lower body 120 when the screen 230 is attached to the pocket 210. In other words, the screen 230 preferably has the same circumference or radius of curvature as the lower inner sidewall 120b so that the screen 230 does not protrude toward the interior space S1 of the cyclone body 100. The screen 230 preferably does not break the airflow of the interior space S1 of the cyclone body 100 thereby maintaining a substantially continuous airflow along the lower inner sidewall 120b.

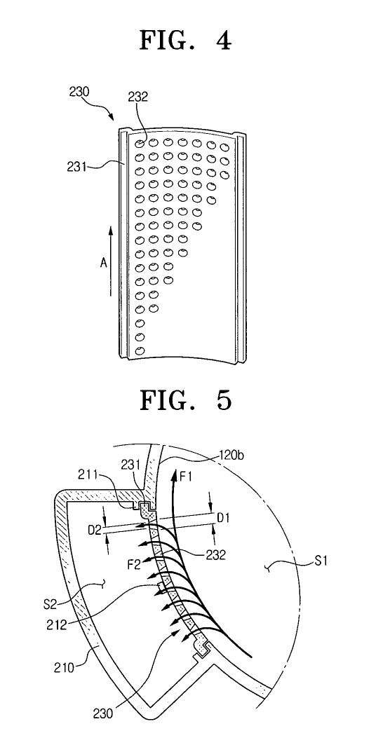

As shown in FIGS. 4 and 5, the screen 230 has a plurality of tapered dust passage openings 232 of which the diameter decreases gradually from the interior space S1 to the enclosed space S2. Thus, each side of the individual dust passage openings 232 has a different diameter. In more detail, one side of the dust passage opening 232 facing the interior space S1 has a first diameter D1, while the other side of the dust passage opening 232 facing to the enclosed space S2 has a second diameter D2. In this exemplary embodiment, the first diameter D1 is greater than the second diameter D2. Particularly, the second diameter D2 can be varied depending on a targeted size of dust to be collected.

The number of the dust passage openings 232 increases in an upward direction of an arrow A pointing upwardly from a bottom side of the screen 230. Thus, the dust passage openings 232 are disposed in an inverted triangular shape. The inverted triangular arrangement of the dust passage openings 232 minimizes the clogging of the dust passage openings 232 caused by dust piled up from a bottom side to an upper side of the screen 230.

Referring to FIG. 5, among the dust particles rotating in a direction of an arrow F1 at the interior space S1 along the lower inner sidewall 120b and the upper inner sidewall 110b of the cyclone body 100, those microscopic particulates of dust smaller than the second diameter D2 pass through the dust passage openings 232 in a direction of an arrow F2 by the centrifugal force and are collected within the enclosed space S2.

Meanwhile, the collected microscopic particulates of dust can be discarded along with dust collected at the bottom surface 120c of the lower body 120 shown in FIG. 2. That is, when the upper body 110 is detached from the lower body 120 to discard the dust collected at the bottom surface 120c, the pocket lid 220 covering the pocket 210 is also detached. Then, the lower body 120 detached from the upper body 110 is turned upside down to discard the dust collected at the bottom surface 120c of the lower body 120 and the collected microscopic particulates of dust within the enclosed case S2.

Hereinafter, operation of the cyclone dust-separating apparatus 10 with the above-described configuration will be described in detail.

With reference to FIGS. 1 through 5, dust-laden air sucked into the inlet passage 111 descends as rotating helically around the cyclone body 100 in a direction of the arrow F1. At this time, the dust included in the drawn-in air bounces toward the upper inner sidewall 110b and the lower inner sidewall 120b of the cyclone body 100 because of the centrifugal force, and then rotates along the lower inner sidewall 120b and the upper inner sidewall 110b. Since the centrifugal force exerted on the air borne dust becomes weaker as going down from the upper inner sidewall 110b of the upper body 110 to the lower inner sidewall 120b of the lower body 120, the dust piles up or accumulates on the bottom surface 120c of the lower body 120.

Concurrently, among particles of the dust rotating along the lower inner sidewall 120b and the upper inner sidewall 110b, those microscopic particulates smaller than the second diameter D2 of the dust passage opening 232 pass through the dust passage openings 232 in a direction of the arrow F2 by the centrifugation and are collected within the enclosed space S2.

When the ascending airflow, the descending airflow and the airflow around the lower body become unstable due to external environmental changes, some amount of the dust collected at the bottom surface 120c of the lower body 120 ascends. At this time, large and small particles of the dust are not allowed to exhaust out of the outlet passage 112 as being blocked by the skirt 114 and the grill 113. The dust collection units 200 recollect those microscopic particulates of dust smaller than the second diameter D2. Accordingly, in contrast to the conventional cyclone dust collecting apparatus, the cyclone dust-separating apparatus in accordance with the present invention is capable of preventing the microscopic particulates from exhausting directly out of the outlet passage 112.

Afterwards, the air, which has now been separated from the dust containing large, small and microscopic particles, exhausts to an external part of the cyclone dust-separating apparatus through the outlet passage 112.

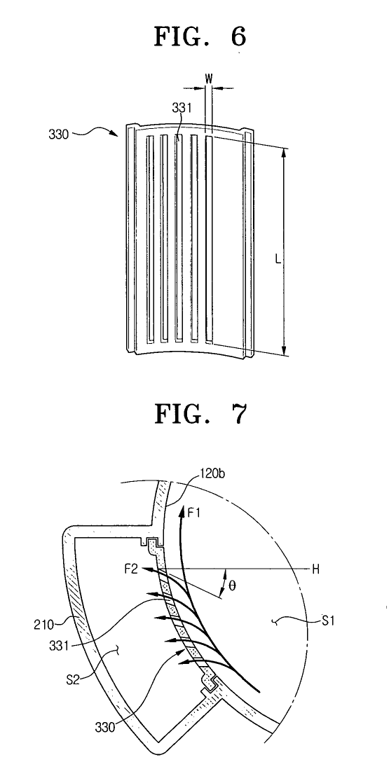

FIGS. 6 and 7 show another embodied screen 330 in accordance with the present invention.

As illustrated in FIGS. 6 and 7, the screen 330 includes a plurality of vertical slits 331 that each have a width of W and a length of L, instead of the dust passage openings 232 of the screen 230 of FIG. 3. In this embodiment of screen 330, the width W can be varied depending on an intended size of microscopic particulates of dust to be collected. Also, each of the slits 331 is inclined or angled in a direction that the airflow rotates in order to make the microscopic particulates rotating along the lower inner sidewall 120b and the upper inner sidewall 110b easily move into the enclosed space S2. That is, as shown in FIG. 7, each of the slits 331 is inclined in a predetermined angle θ from a horizontal line H.

As described above, among the dust rotating in a direction of the arrow F1 along the lower and the upper inner sidewalls 120b and 110b, those microscopic particulates smaller than the width W of the slit 331 pass through the slits 331 in a direction of the arrow F2 and are collected within the enclosed space S2.

On the basis of the cyclone dust-separating apparatus manufactured in accordance with the present invention, the plurality of dust collection units for collecting the microscopic particulates are installed on the circumferential surface of the cyclone body. The adaptation of the plurality of dust collection units provides at least the following effects. First, there is an improvement on the microscopic particulate collection efficiency. Second, it is possible to decrease the frequency that microscopic particulates of dust clog a motor protection filter and an exhaust filter of a vacuum cleaner having a vacuum source. Third, it is further possible to prevent occurrences of weakened suction power of a vacuum cleaner caused by clogged filters.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A cyclone dust-separating apparatus, comprising:
a cyclone body; and
at least one dust collection unit formed on a circumferential surface of the cyclone body, wherein the at least one dust collection unit collects microscopic particulates of dust.

2. The cyclone dust-separating apparatus of claim 1, wherein the at least one dust collection unit comprises:
a pocket extending outwardly from an exterior surface of the cyclone body;
a pocket lid for covering the pocket; and
a screen in the pocket.

3. The cyclone dust-separating apparatus of claim 2, wherein the pocket, the pocket lid and the screen at least partially define an enclosed space at which the microscopic particulates of dust existing within an interior space of the cyclone body are collected.

4. The cyclone dust-separating apparatus of claim 3, wherein the screen does not protrude into the interior space of the cyclone body.

5. The cyclone dust-separating apparatus of claim 4, wherein the screen has the same circumference as an inner sidewall of the cyclone body thereby preventing the screen from protruding into the interior space of the cyclone body.

6. The cyclone dust-separating apparatus of claim 5, wherein the screen includes a plurality of dust passage openings.

7. The cyclone dust-separating apparatus of claim 6, wherein the plurality of dust passage openings increase in number in a direction from a bottom part of the screen to an upper part of the screen.

8. The cyclone dust-separating apparatus of claim 7, wherein each of the plurality of dust passage openings has a diameter that decreases going from the interior space to the enclosed space.

9. The cyclone dust-separating apparatus of claim 4, wherein the screen includes a plurality of slits.

10. The cyclone dust-separating apparatus of claim 9, wherein each of the plurality of slits is in a vertical direction.

11. The cyclone dust-separating apparatus of claim 9, wherein each of the plurality of slits is inclined in a direction to which air existing within the interior space rotates.

12. The cyclone dust-separating apparatus of claim 2, wherein the screen is attachable to and detachable from the pocket.

13. The cyclone dust-separating apparatus of claim 12, wherein the screen and pocket are slidably connected.

14. The cyclone dust-separating apparatus of claim 4, wherein the screen and pocket are pivotally connected.

15. A vacuum cleaner comprising:
a vacuum source;
a cyclone body in fluid communication with the vacuum source; and
at least one dust collection unit formed on a circumferential surface of the cyclone body, wherein the at least one dust collection unit collects microscopic particulates of dust.

16. The vacuum cleaner of claim 15, wherein the at least one dust collection unit comprises:
a pocket extending outwardly from an exterior surface of the cyclone body;
a pocket lid for covering the pocket; and
a screen removably connectable to the pocket.

17. The vacuum cleaner of claim 16, wherein the pocket, the pocket lid and the screen at least partially define an enclosed space at which the microscopic particulates of dust existing within an interior space of the cyclone body are collected, and wherein the screen has the same circumference as an inner sidewall of the cyclone body thereby preventing the screen from protruding into the interior space of the cyclone body.

18. The vacuum cleaner of claim 17, wherein the screen includes a plurality of dust passage openings that increase in number in a direction from a bottom part of the screen to an upper part of the screen.

19. A method of separating microscopic particulates of dust from air suctioned by a vacuum cleaner, the method comprising:
supplying the air to a cyclone body;
rotating the air helically in the cyclone body thereby applying a centrifugal force to the dust that moves the dust towards and rotates the dust about an inner sidewall of the cyclone body;
collecting the microscopic particulates of dust through a screen disposed along the inner sidewall, the screen having openings sized for collection of only the microscopic particulates;
preventing dust that has accumulated in the inner space of the cyclone body from being exhausted via a skirt and grill; and
exhausting the air through an outlet passage of the cyclone body.

20. The method of claim 19, further comprising disposing the screen along the inner wall of the cyclone body thereby maintaining a substantially continuous airflow along the inner sidewall of the cyclone body.
